(19) United States
(12) Patent Application Publication
(10) Pub. No.: US 2020/0049946 A1
(43) Pub. Date: Feb. 13, 2020

(54) DISPLAY APPARATUS AND METHOD OF DISPLAYING USING GAZE PREDICTION AND IMAGE STEERING

(71) Applicant: Varjo Technologies Oy, Helsinki (FI)

(72) Inventors: Ari Antti Erik Peuhkurinen, Helsinki (FI); Ville Ilmari Miettinen, Helsinki (FI)

(21) Appl. No.: 16/100,306

(22) Filed: Aug. 10, 2018

(51) Int. Cl. G02B 7/28; G06F 3/01; G02B 27/00; G06T 15/00

(52) U.S. Cl. CPC G02B 7/287; G06T 15/005; G02B 27/0093; G06F 3/013

(57) ABSTRACT

A display apparatus including configuration of gaze sensors; gaze predictor module configured to process sensor data collected by aforesaid configuration to determine current gaze location and gaze velocity and/or acceleration, and to predict gaze location and gaze velocity and/or acceleration of user; image processing module configured to process input image for generating first image having first resolution and second image having second resolution, second resolution being higher than first resolution; first and second image renderers that render first and second image, respectively; optical combiner for optically combining projections of first and second images; and image steering unit configured to determine region of optical combiner onto which projection of second image is to be focused, and to make adjustment to focus projection of second image on said region; wherein second image renderer is switched off or dimmed during adjusting phase of image steering unit when said unit is making adjustment.

### TECHNICAL FIELD

The present disclosure relates generally to representation of visual information; and more specifically, to display apparatuses comprising configurations of gaze sensors, gaze predictor modules, image processing modules, image renderers, optical combiners and image steering units. Furthermore, the present disclosure also relates to methods of displaying via the aforementioned display apparatuses.

### BACKGROUND

Nowadays, several technologies are being used to present interactive simulated environments to users of specialized devices. Such technologies include virtual reality, augmented reality, mixed reality, and the like. Presently, the users utilize the specialized devices (for example, such as virtual reality headsets, a pair of virtual reality glasses, augmented reality headsets, a pair of augmented reality glasses, mixed reality headsets, a pair of mixed reality glasses, and the like) for experiencing and interacting with such simulated environments. Specifically, the simulated environments enhance the user's experience of reality around him/her by providing the user with a feeling of immersion within the simulated environment, using contemporary techniques such as stereoscopy.

Generally, while using such specialized devices, the user's eyes keep moving. For example, the user may be looking at a left portion of a given simulated environment at a given time instant, and may move his/her eyes to look at a right portion of the given simulated environment at a subsequent time instant. Therefore, nowadays, such specialized devices have started to employ a gaze-tracking (namely, eye tracking) technique to determine a gaze direction of the user. Such gaze-tracking is associated with determination of the gaze direction of user, based on movement of the eyes of the user.

Commonly, there occur four different types of eye movements: fixational movements, vergence movements, saccadic movements and pursuit movements. Firstly, the fixational movements pertain to movements that occur within fixations, wherein the fixations are comparably static points during which the user's eyes are relatively stationary. However, the eye is never completely stationary and thus, the gaze direction of the use may drift. Therefore, very small fixational eye-movements, namely microsaccades, are employed to correct such drifting of the gaze direction of the user. Secondly, the vergence movements involve cooperative movement of both eyes of the user in opposite directions such that projections of an object are incident at a same spot on retina of the both eyes. Thirdly, the saccadic movements involve rapid movement of eyes from one position to another position while scanning a given visual scene/image. Furthermore, the saccadic movements include: short saccadic movements and long saccadic movements. In short saccadic movements, the gaze of the user shifts within a region of interest, whilst in long saccadic movements, the gaze of the user shifts from one region of interest to another region of interest within the given visual scene/image. Lastly, the pursuit movements relates to smooth movements of the user's eyes while following a moving object.

However, existing specialized devices are limited in their ability to accommodate the aforementioned eye movements to determine the gaze direction of the user. In an example, amongst the saccadic movements, a long saccade may occur 3 to 4 times per second and may last for about 5 to 80 milliseconds. In such a case, during the saccadic movements, the visual scene displayed by the specialized devices may not be properly perceived by the user. Furthermore, during the saccadic movement, the capability of the user to receive accurate visual information is substantially reduced. For example, there may be a time interval when the user's visual system may provide inaccurate visual information to the user's brain and thus the user may experience a blackout. As a result, a quality of the user's experience of the simulated environment is severely diminished due to sub-optimal immersiveness.

Therefore, in light of the foregoing discussion, there exists a need to overcome the aforementioned drawbacks associated with specialized devices for providing simulated environments to users.

### SUMMARY

The present disclosure seeks to provide a display apparatus. The present disclosure also seeks to provide a method of displaying, via a display apparatus. The present disclosure seeks to provide a solution to the existing problem of suboptimal accommodation of changes in a user's gaze on account of movement of the user's eyes within conventional specialized devices. An aim of the present disclosure is to provide a solution that overcomes at least partially the problems encountered in prior art, and provides a display apparatus that efficiently provides a seamless, immersive simulated environment to the user, even upon changes in the user's gaze.

In one aspect, an embodiment of the present disclosure provides a display apparatus comprising:
a configuration of gaze sensors;
a gaze predictor module configured to process sensor data collected by the configuration of gaze sensors to determine a current gaze location and a current gaze velocity and/or acceleration of a user, and to predict a gaze location and a gaze velocity and/or acceleration of the user, based at least partially upon the current gaze location and the current gaze velocity and/or acceleration;
an image processing module configured to process an input image, based upon the predicted gaze location and the predicted gaze velocity and/or acceleration, to generate at least a first image and a second image, wherein the first image has a first resolution, while the second image has a second resolution, the second resolution being higher than the first resolution;
at least one first image renderer and at least one second image renderer that, in operation, render the first image and the second image, respectively;
at least one optical combiner for optically combining a projection of the first image with a projection of the second image; and
an image steering unit configured to determine, based upon the predicted gaze location and the predicted gaze velocity and/or acceleration, a region of the at least one optical combiner onto which the projection of the second image is to be focused, and to make an adjustment to focus the projection of the second image on said region of the at least one optical combiner;
   wherein the at least one second image renderer is to be switched off or dimmed during an adjusting phase of the image steering unit when the image steering unit is making the adjustment.

In another aspect, an embodiment of the present disclosure provides a method of displaying, via a display apparatus, the method comprising:
processing sensor data collected by a configuration of gaze sensors of the display apparatus to determine a current gaze location and a current gaze velocity and/or acceleration of a user;
predicting a gaze location and a gaze velocity and/or acceleration of the user, based at least partially upon the current gaze location and the current gaze velocity and/or acceleration;
processing an input image, based upon the predicted gaze location and the predicted gaze velocity and/or acceleration, to generate at least a first image and a second image, wherein the first image has a first resolution, while the second image has a second resolution, the second resolution being higher than the first resolution;
rendering, via at least one first image renderer and at least one second image renderer of the display apparatus, the first image and the second image, respectively, wherein a projection of the first image is optically combined with a projection of the second image using at least one optical combiner of the display apparatus;
determining, based upon the predicted gaze location and the predicted gaze velocity and/or acceleration, a region of the at least one optical combiner onto which the projection of the second image is to be focused;
employing an image steering unit of the display apparatus to make an adjustment to focus the projection of the second image on said region of the at least one optical combiner; and
switching off or dimming the at least one second image renderer during an adjusting phase of the image steering unit when the image steering unit is making the adjustment.

Embodiments of the present disclosure substantially eliminate or at least partially address the aforementioned problems in the prior art, and enables provision of an immersive simulated environment to a user, whist accommodating changes in the user's gaze in a manner that the user's experience of the simulated environment is seamless.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 illustrates a block diagram of architecture of a display apparatus, in accordance with an embodiment of the present disclosure;

FIG. 2 illustrates an exemplary information flow when a user uses a display apparatus, in accordance with an embodiment of the present disclosure;

FIG. 3 illustrates an exemplary timeline of exemplary operational steps of a display apparatus, in accordance with an embodiment of the present disclosure;

FIGS. 4A, 4B and 4C illustrate exemplary illustrations of image rendering formats of a given image, that act as input to a given image renderer, in accordance with various embodiments of the present disclosure; and

FIG. 5 illustrates steps of a method of displaying, via a display apparatus, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides a display apparatus comprising:
a configuration of gaze sensors;
a gaze predictor module configured to process sensor data collected by the configuration of gaze sensors to determine a current gaze location and a current gaze velocity and/or acceleration of a user, and to predict a gaze location and a gaze velocity and/or acceleration of the user, based at least partially upon the current gaze location and the current gaze velocity and/or acceleration;
an image processing module configured to process an input image, based upon the predicted gaze location and the predicted gaze velocity and/or acceleration, to generate at least a first image and a second image, wherein the first image has a first resolution, while the second image has a second resolution, the second resolution being higher than the first resolution;
at least one first image renderer and at least one second image renderer that, in operation, render the first image and the second image, respectively;
at least one optical combiner for optically combining a projection of the first image with a projection of the second image; and
an image steering unit configured to determine, based upon the predicted gaze location and the predicted gaze velocity and/or acceleration, a region of the at least one optical combiner onto which the projection of the second image is to be focused, and to make an adjustment to focus the projection of the second image on said region of the at least one optical combiner;
   wherein the at least one second image renderer is to be switched off or dimmed during an adjusting phase of the image steering unit when the image steering unit is making the adjustment.

In another aspect, an embodiment of the present disclosure provides a method of displaying, via a display apparatus, the method comprising:
processing sensor data collected by a configuration of gaze sensors of the display apparatus to determine a current gaze location and a current gaze velocity and/or acceleration of a user;
predicting a gaze location and a gaze velocity and/or acceleration of the user, based at least partially upon the current gaze location and the current gaze velocity and/or acceleration;
processing an input image, based upon the predicted gaze location and the predicted gaze velocity and/or acceleration, to generate at least a first image and a second image, wherein the first image has a first resolution, while the second image has a second resolution, the second resolution being higher than the first resolution;
rendering, via at least one first image renderer and at least one second image renderer of the display apparatus, the first image and the second image, respectively, wherein a projection of the first image is optically combined with a projection of the second image using at least one optical combiner of the display apparatus;
determining, based upon the predicted gaze location and the predicted gaze velocity and/or acceleration, a region of the at least one optical combiner onto which the projection of the second image is to be focused;
employing an image steering unit of the display apparatus to make an adjustment to focus the projection of the second image on said region of the at least one optical combiner; and
switching off or dimming the at least one second image renderer during an adjusting phase of the image steering unit when the image steering unit is making the adjustment.

The present disclosure provides the aforementioned display apparatus and the aforementioned method of displaying, via such a display apparatus. The display apparatus simulates active foveation of a human visual system whilst presenting a simulated environment to a user. Notably, the display apparatus utilizes the predicted gaze location and the predicted gaze velocity and/or acceleration of the user, to control operations of its various components in a manner that the user enjoys an uninterrupted viewing experience even whilst various operative adjustments are being carried out within the display apparatus. Beneficially, when components of the display apparatus are optimally arranged, the visual scene is provided to the user whilst emulating foveation of the human visual system. Therefore, since the display apparatus employs predictions pertaining to the user's gaze for optimally controlling operations within the display apparatus, the display apparatus efficiently adjusts the simulated environment even upon movement of the user's eyes. Beneficially, the method of displaying using the described display apparatus is systematic, and allows for efficiently providing the simulated environment to the user.

Throughout the present disclosure, the term “display apparatus” used herein relates to specialized equipment that is configured to display a visual scene of a simulated environment to the user of the display apparatus when the display apparatus is worn by the user on his/her head. Examples of the simulated environment can include a fully virtual environment (namely, a virtual reality environment) as well as a real world environment including simulated objects therein (namely, an augmented reality environment, a mixed reality environment, and the like). Therefore, the display apparatus is operable to act as a device (for example, such as a virtual reality headset, an augmented reality headset, a mixed reality headset, a pair of virtual reality glasses, a pair of augmented reality glasses, a pair of mixed reality glasses and so forth) for presenting the simulated environment to the user.

Throughout the present disclosure, the term “visual scene” can be understood to relate to a sequence of images that are to be presented to the user, via the display apparatus. In an example, the visual scene may be a virtual reality movie. In another example, the visual scene may be an educational augmented reality video. In yet another example, the visual scene may be a mixed reality game.

It will be appreciated that in operation, various components of the display apparatus functionally cooperate with each other, to provide the user with a seamless viewing experience. In other words, the various components of the display apparatus operate in a substantially synchronized manner, to enhance the user's experience of the simulated environment. Such a manner of operation necessitates the various components (notably, the configuration of gaze sensors, the gaze predictor module, the image processing module, the at least one first image renderer and the at least one second image renderer, the at least one optical combiner and the image steering unit) to be coupled in communication with one another. Optionally, the components of the display apparatus are coupled in communication with each other via a processor of the display apparatus. Such a processor acts as an intermediary device that manages communication between the components of the display apparatus. Additionally or alternatively, optionally, the components are coupled in communication with each other via a common bus. Yet additionally or alternatively, the components are directly coupled in communication with each other. Therefore, even though the components of the display apparatus operate separately, the communicable coupling therebetween enables them to work in the substantially synchronized manner.

As mentioned previously, the display apparatus comprises the configuration of gaze sensors. Throughout the present disclosure, the term “configuration of gaze sensors” relates to a group of specialized sensor equipment that allows for detecting and/or monitoring the user's gaze. In operation, the configuration of gaze sensors collects sensor data pertaining to the user's gaze by way of monitoring a gaze direction of the user and/or monitoring movement of the user's head (which, in turn, moves the user's eyes). Therefore, the configuration of gaze sensors can be understood to act as a means for detecting a gaze direction of the user and/or a means for tracking a head orientation of the user. Notably, the detected gaze direction of the user may be substantially straight, substantially sideways, substantially upwards, substantially downwards, or any combination thereof. Similarly, the orientation of user's head user may be substantially straight, substantially sideways, substantially upwards, substantially downwards, or any combination thereof. It is to be understood that the detected gaze direction of the user and the orientation of user's head user may or may not be similar. In an example, the orientation of the user's head may be substantially straight and his/her gaze may also be substantially straight. In another example, the orientation of the user's head may be substantially straight but his/her gaze may be substantially sideways.

It will be appreciated that gaze sensors of the aforesaid configuration can be employed for both eyes of the user on a shared-basis. Alternatively, separate gaze sensors of the aforesaid configuration can be employed for separate eyes of the user.

Optionally, a given gaze sensor is implemented by way of at least one illuminator for emitting light to illuminate the user's eyes when the display apparatus is worn by the user on his/her head, and at least one image sensor for capturing at least one image of reflections of the light from the user's eyes. In such a case, sensor data collected by the given gaze sensor relates to the at least one image of the user's eyes, as captured by the at least one image sensor. Furthermore, optionally, the at least one image of the user's eyes depicts the pupils of the user's eyes and the reflections of the light from the user's eyes. Optionally, the at least one illuminator is configured to emit light of infrared wavelength, near-infrared wavelength, or visible wavelength. Optionally, the at least one illuminator is implemented by way of at least one of: an infrared light emitting diode, an infrared laser, an infrared light projector, a visible light emitting diode, a visible light laser, a visible light projector. Optionally, the at least one illuminator is implemented by way of at least one pixel of the at least one first image renderer and/or the at least one second image renderer. It will be appreciated that such a gaze sensor acts as the means for detecting the gaze direction of the user.

Optionally, a given gaze sensor is implemented by way of at least one accelerometer. In such a case, sensor data collected by the at least one accelerometer allows for determining gaze velocity and/or acceleration of the user by tracking movement of the user's head. It will be appreciated that such a gaze sensor acts as the means for tracking the head orientation of the user.

Optionally, a given gaze sensor is implemented by way of at least one gyroscope. In such a case, sensor data collected by the at least one accelerometer allows for determining the gaze velocity and/or acceleration of the user by tracking orientation of the user's head. It will be appreciated that such a gaze sensor acts as the means for tracking the head orientation of the user.

In an example implementation, the configuration of gaze sensors may comprise a first gaze sensor, a second gaze sensor and a third gaze sensor. In such a case, the first gaze sensor may be implemented by way of an illuminator for emitting light to illuminate the user's eyes and an image sensor for capturing an image of reflections of the light from the user's eyes. Furthermore, the second gaze sensor may be implemented by way of two accelerometers and the third gaze sensor may be implemented by way of a gyroscope. Therefore, such a configuration of gaze sensors allows for detecting the gaze direction of the user and tracking the head orientation of the user.

As mentioned previously, the display apparatus further comprises the gaze predictor module that is configured to process sensor data collected by the configuration of gaze sensors to determine the current gaze location and the current gaze velocity and/or acceleration of the user, and to predict the gaze location and the gaze velocity and/or acceleration of the user, based at least partially upon the current gaze location and the current gaze velocity and/or acceleration. Alternatively, optionally, the configuration of gaze sensors is configured to process the sensor data collected thereby to determine the current gaze location and the current gaze-velocity and/or acceleration of the user, and the gaze predictor module is configured to predict the gaze location and the gaze velocity and/or acceleration of the user based at least partially upon the current gaze location and the current gaze velocity and/or acceleration. Throughout the present disclosure, the term “gaze location” relates to a position of a point or a region within the visual scene whereat the user's gaze is directed, the term “gaze velocity” relates to a rate of change (namely, shifting) of the user's gaze, and the term “gaze acceleration” relates to a rate of change of gaze velocity of the user. Notably, the current gaze location of the user is determined by using the determined gaze direction to identify the position of the point or the region whereat the user's gaze is directed. Furthermore, the current gaze velocity and/or acceleration is/are determined by processing sensor data pertaining to the determined gaze direction and the movement and/or orientation of the user's head. It will be appreciated that the gaze velocity and/or acceleration can be determined in instances when there is movement of the user's head, as well as when the user's head is still. In an instance, when there is the user's head moves, the current gaze velocity and/or acceleration may be determined by processing the sensor data pertaining to the determined gaze direction of the user's eyes and the determined movement and/or orientation of the user's head. In another instance, when the user's head is still, the current gaze velocity and/or acceleration may be determined by processing the sensor data pertaining to the determined gaze direction and the determined movement of the user's eyes.

Throughout the present disclosure, the term “gaze predictor module” relates to specialized hardware, software, firmware, or a combination of these, that provides at least a predictive functionality for the display apparatus. Notably, the sensor data is transmitted in raw or processed form, from the configuration of gaze sensors to the gaze predictor module, via a high-speed physical or wireless data communication channel. It is to be understood that when the sensor data is transmitted from the configuration of gaze sensors in raw form, the gaze predictor module also provides a processing functionality (for processing the sensor data) within the display apparatus, in addition to the predictive functionality.

Optionally, to predict the gaze location and the gaze velocity and/or acceleration of the user, the gaze predictor module employs a parameterized approximation function having input parameters comprising at least the current gaze location and the current gaze velocity and/or acceleration of the user. The output of the parametrized approximation function is the predicted gaze location and the predicted gaze velocity and/or acceleration of the user.

Additionally or alternatively, optionally, to predict the gaze location and the gaze velocity and/or acceleration of the user, the gaze predictor module employs at least one artificial intelligence algorithm. In such a case, the at least one artificial intelligence algorithm can utilise neural networks for making the aforesaid predictions. Such neural networks can be understood to be a part of a learning model for predicting the gaze location and the gaze velocity and/or acceleration of the user. As an example, the least one artificial intelligence algorithm may be employed to train a neural network over a period of time by way of supervised learning, for making accurate predictions. Furthermore, the at least one artificial intelligence algorithm can utilise a computer vision algorithm for making the aforesaid predictions. Yet additionally or alternatively, optionally, to predict the gaze location and the gaze velocity and/or acceleration of the user, the gaze predictor module utilises user-specific historical gaze information. In such a case, the user-specific historical gaze information may include previously sensed data by the configuration of gaze sensors for a given user, previously determined gaze location(s) of the given user, previously determined gaze velocity and/or acceleration of the given user, previously predicted gaze location(s) for the given user, previously predicted gaze velocity and/or acceleration for the given user, and the like. Therefore, such user-specific historical gaze information can be processed to identify patterns of eye movement of the user, fixation duration of the user, gaze velocity trends of the user, and the like, which are beneficial in enhancing accuracy of the predicted gaze location and the predicted gaze velocity and/or acceleration of the user. Furthermore, optionally, such user-specific historical gaze information is a part of the learning model for predicting the gaze location and the gaze velocity and/or acceleration of the user. Optionally, in this regard, the at least one artificial intelligence algorithm is to be employed for processing the user-specific historical gaze information.

In an example, upon processing the sensor data collected by the configuration of gaze sensors, the gaze predictor module may determine the current gaze location of the user to be at a central region of the visual scene, and the current gaze velocity of the user to be 5 degrees per second towards a right portion of the visual scene. In such an instance, if an angular width of the visual scene is 40 degrees, the gaze predictor module may predict the gaze location of the user after 4 seconds to be at a right side periphery of the visual scene. Furthermore, the gaze predictor module may predict the gaze velocity of the user after 4 seconds to be zero.

In another example, upon processing the sensor data collected by the configuration of gaze sensors, the gaze predictor module may determine the current gaze location to be at a top region of the visual scene, and the current gaze velocity of the user to be very slow (for example, such as 1 degree per second downwards). In such an instance, if an angular height of the visual scene is 100 degrees, the gaze predictor module may still predict the gaze location of the user after 5 seconds to be at a bottom periphery of the visual scene since the user-specific historical gaze information may indicate that previously determined gaze acceleration of the given user is very high (for example, such as 4 degrees per second squared).

In yet another example, upon processing the sensor data collected by the configuration of gaze sensors, the gaze predictor module may determine the predicted gaze location of the user to be at a given region of interest within the visual scene. In such a case, different regions of the visual scene may have different rendering weights associated therewith, wherein the region of interest has highest weight among the different regions. Therefore, the gaze predictor module may predict the gaze location of the user, based upon information pertaining to the rendering weight of the given region of interest within the visual scene since the user's gaze may be drawn towards such a region of interest.

Optionally, the configuration of sensors and/or the gaze predictor module is/are configured to determine a current movement status of the user's eyes, based upon the determined current gaze location and the current gaze velocity and/or acceleration of the user. Furthermore, optionally, the configuration of sensors and/or the gaze predictor module is/are configured to communicate the current movement status of the user's eyes to remaining components of the display apparatus. Examples of the current movement status of the user's eyes include, but are not limited to, “starting to move”, “moving”, “focusing”, and “focused”.

Optionally, the gaze predictor module is configured to predict a movement status of the user's eyes, based upon the current movement status of the user's eyes. Furthermore, optionally, the gaze predictor module is configured to communicate the predicted movement status of the user's eyes to the remaining components of the display apparatus. Optionally, in this regard, the gaze predictor module is configured to communicate the predicted movement status of the user's eyes to at least one of: the configuration of gaze sensors, the image processing module, the at least one first image renderer, the at least one second image renderer, the at least one optical combiner, the image steering unit. As a result, the remaining components can suitably manage their future operations according to the predicted movement status. It will be appreciated that knowledge of the predicted movement status of the user's eyes allows for the remaining components to cooperate optimally in a manner that enables provision of an optimal viewing experience to the user of the display apparatus. In other words, the knowledge of the predicted movement status of the user's eyes allows for the remaining components of the display apparatus to operate in the substantially synchronized manner as described hereinabove.

Optionally, the gaze predictor module is configured to predict the gaze location and the gaze velocity and/or acceleration of the user, based also upon information pertaining to the visual scene being presented to the user. Notably, the visual scene being presented to the user depicts various objects and/or features which generally have specific characteristics associated therewith. Examples of such characteristics include, but are not limited to, visual characteristics, material composition, audio characteristics, haptic characteristics, and physical interaction characteristics. The gaze predictor module utilizes knowledge pertaining to the aforesaid characteristics of objects and/or features within the visual scene to predict how the user's eyes would react whilst viewing the visual scene. As an example, for a given visual scene that corresponds to a given sequence of images, the gaze predictor module can predict the gaze location and the gaze velocity of the user, based upon visual characteristics of objects depicted in the given sequence of images. In such a case, if a given image of the sequence depicts a small-sized object in a central portion thereof, and its succeeding image depicts a large-sized object in a right portion thereof, the gaze predictor module can utilise such information pertaining to the visual scene, to predict that the gaze location of the user would shift rightwards with a given gaze velocity.

Optionally, the information pertaining to the visual scene comprises information indicative of a location of an object present in the visual scene that has at least one of: an audio feature of interest, a visual feature of interest, a physical interaction with another object present in the visual scene. Notably, if the object has audio features of interest, visual features of interest, physical interactions with other objects, and so forth, there exists a high likelihood that the user's gaze would be directed towards such an object since such characteristics generally attract the user's attention. Therefore, knowledge of the location of such a noticeable (namely, eye-catching) object facilitates the gaze predictor module in making intelligent and accurate predictions of the gaze location and the gaze velocity and/or acceleration of the user. It is to be understood that the term “object” encompasses both virtual objects as well as actual real-world objects in the real-world environment whereat the user is physically present. Notably, the virtual objects could be digitally simulated objects (namely, virtual reality objects) and/or virtual depictions of real-world objects present in a given real-world environment (namely, mixed reality objects). Such depictions of the real-world objects are obtained, for example, by way of images of the given real-world environment that can be obtained via a video see-through arrangement (such as cameras mounted on an outer surface of the display apparatus). Furthermore, the actual real-world objects (in the real-world environment of the user) can be directly shown to the user via an optical see-through arrangement (such as a semi-transparent lens).

In an example, a given visual scene of a virtual home environment may represent a virtual telephone. The virtual telephone may have an audio feature of interest associated therewith, for example, such as a ringing sound of the virtual telephone. In such an example, given the location of the virtual telephone in a given image of the visual scene, the gaze predictor module can predict the gaze location of the user to be at a region of the given image that depicts the virtual telephone. Furthermore, the gaze predictor module can also predict the gaze velocity and/or acceleration of the user by way of the predicted gaze location of the user, and the user's current gaze location when he/she views a preceding image of the given image.

In another example, a given visual scene of an augmented reality shooting game may represent a virtual enemy that is to be shot by a player of the augmented reality shooting game (notably, the user of the display apparatus). Furthermore, the virtual enemy may have a visual feature of interest associated therewith, for example, such as a distinct physical appearance of the virtual enemy. In such an example, given the location of the virtual enemy in the visual scene, the gaze predictor module can predict the gaze location and the gaze velocity and/or acceleration of the user viewing the given visual scene.

In yet another example, a given visual scene of a mixed reality home environment may represent a virtual ball and a virtual representation of a real-world glass window. The virtual ball may physically interact with the virtual glass window in a manner that when the virtual ball strikes the virtual glass window, the virtual glass window is shattered. In such an example, given the location of the virtual ball in the visual scene, the gaze predictor module can predict the gaze location and the gaze velocity and/or acceleration of the user viewing the given visual scene.

Optionally, to recognize at least one object present in a given visual scene, the gaze predictor module employs at least one computer vision algorithm. The at least one computer vision algorithm processes a given sequence of images of the given visual scene to extract information related to shapes and/or arrangements therein, to recognize the at least one object. More optionally, the gaze predictor module is configured to predict the gaze location and the gaze velocity and/or acceleration of the user, based upon the information pertaining to the at least one object present in the visual scene. Examples of the at least one computer vision algorithm include, but are not limited to, Scale-Invariant feature transform (SIFT) algorithm, Speeded up Robust Features (SURF) algorithm, and Convolutional Neural Networks algorithm.

As mentioned previously, the display apparatus comprises the image processing module configured to process the input image, based upon the predicted gaze location and the predicted gaze velocity and/or acceleration, to generate at least the first image and the second image, wherein the first image has the first resolution, while the second image has the second resolution, the second resolution being higher than the first resolution. Throughout the present disclosure, the term “image processing module” relates to specialized hardware, software, firmware, or a combination of these, that provides image processing functionality within the display apparatus. Notably, the predicted gaze location and the predicted gaze velocity and/or acceleration of the user is transmitted in raw or processed form, from the gaze predictor module to the image processing module, via a high-speed physical or wireless data communication channel. The image processing module utilizes predictive deductions made by the gaze predictor module for implementing the aforesaid image processing functionality. As a result, the sequence of images constituting the visual scene are optimally processed in a manner that the user of the display apparatus is provided a seamless, immersive viewing experience.

It will be appreciated that when the current gaze location and the current gaze velocity and/or acceleration of the user varies, the predicted gaze location and the predicted gaze velocity and/or acceleration of the user also varies. Therefore, in such a scenario, the image processing module generally operates continuously. Generally, the current gaze location and the current gaze velocity and/or acceleration of the user can be understood to vary continuously when the display apparatus is in use.

Throughout the present disclosure, the term “input image” relates to an image depicting a constituent view of the visual scene that is to be presented to the user of the display apparatus. In one embodiment, the image processing module obtains the input image from an imaging device (for example, such as a camera) that is mounted on the display apparatus. In such a case, the imaging device is configured to capture an image of the real-world environment whereat the user is physically present. Such a captured image is the input image wherefrom the first image and the second image are to be generated. In another embodiment, the image processing module obtains the input image from a remote device having the imaging device mounted thereupon, wherein the remote device is coupled in communication with the image processing module. In such a case, the remote device may be positioned in an environment that is different from the real-world environment whereat the user is physically present. In other words, the user of the display apparatus may be positioned away from the remote device. Optionally, the remote device is one of: a drone, a robot. In yet another embodiment, the image processing module obtains the input image from a memory unit of the display apparatus, the memory unit being coupled in communication with the image processing module. In still another embodiment, the image processing module digitally generates the input image.

It will be appreciated that the image processing module is configured to process the input image to generate multiple images having multiple resolutions, and its operation is not limited to generating only the first image and the second image having different resolutions. For example, the image processing module could also generate a third image, a fourth image, and so on, in a manner that all images have different resolutions.

Throughout the present disclosure, the term “first image” relates to an image corresponding to a first portion of the input image. Similarly, the term “second image” relates to an image corresponding to a second portion of the input image. It will be appreciated that the first portion and/or the second portion of the input image could correspond to only a certain region of the input image, or an entire region of the input image.

Optionally, at least the first image and the second image collectively constitute the input image. In other words, all portions of the input image are captured within a collective set of images generated by the image processing module (notably, at least the first image and the second image).

The second resolution (of the second image) is higher than the first resolution (of the first image). Throughout the present disclosure, the “resolution” of a given image is to be understood in terms of angular resolution of the given image. Notably, the angular resolution of the given image relates to a number of pixels per degree of the given image, when the given image is viewed by the user of the display apparatus. Furthermore, angular resolution can be more commonly referred to as an “apparent resolution” from a perspective of the user's eyes. Specifically, pixels per degree indicative of the second resolution are higher than pixels per degree indicative of the first resolution. As an example, the fovea of the eye of the user may correspond to 2 degrees of visual field and may receive the projection of the second image of angular cross section width equal to 114 pixels indicative of 57 pixels per degree. Furthermore, an angular pixel size corresponding to the second image would equal 2/114 or 0.017. Moreover, in such an example, the retina of the eye may correspond to 180 degrees of visual field and receive projection of the first image of angular cross section width equal to 2700 pixels indicative of 15 pixels per degree. Furthermore, an angular pixel size corresponding to the first image would equal 180/2700 or 0.067. As calculated, the angular pixel size corresponding to the first image is clearly much larger than the angular pixel size corresponding to the second image. However, a total number of pixels is greater for the first image as compared to the second image.

Optionally, whilst processing the input image to generate at least the first image and the second image, the image processing module is configured to perform at least one of:
selection of a rendering parameter of the first image and/or the second image;
addition or removal of image pre-processing, intermediate processing and post-processing phases for the first image and/or the second image;
digital image correction of the first image and/or the second image.

Optionally, the rendering parameter that is to be selected comprises at least one of: image rendering resolution of the first image and/or the second image, image rendering format of the first image and/or the second image, rendering duration of the first image and/or the second image, rendering weight of portions of the first image and/or the second image, portions of the first image and/or the second image that are to be rendered. It is to be understood that “image rendering resolution” of a given image relates to a pixel resolution (namely, number of pixels per unit area) at which the given image is to be rendered by its corresponding image renderer. Furthermore, “image rendering format” relates to a defined type or form in which a given image is to be rendered. Optionally, a given image rendering format that is to be employed for rendering a given image within the display apparatus comprises at least one of: a two-dimensional bitmap, a set of two-dimensional bitmaps, a single dynamic resolution texture, a just-in-time rendered area, a set of rays having constant size and/or shape, a set of rays having variable size and/or shape.

Moreover, “rendering weight” of a given portion of a given image is based upon at least one of: visual attributes of the given portion (for example, such as brightness of the given portion, colour(s) of the given portion, size of the given portion and the like), the predicted gaze location of the user, the predicted gaze velocity and/or acceleration of the user. Notably, the rendering weight of the given portion is to be employed when the given image is being rendered. It will be appreciated that different portions of the given image could have different rendering weights associated therewith. As an example, for a given image, a rendering weight of a portion that substantially corresponds to the current gaze location of the user may be lesser than a rendering weight of another portion that substantially corresponds to the predicted gaze location of the user. Examples of image pre-processing, intermediate processing and post-processing phases include, but are not limited to, low pass filtering, colour processing, gamma correction, image sharpening, image cropping, edge processing, masking (namely, obscuring) a portion of a given image, image brightness adjustment, image resizing, and image segmentation. Notably, the image correction of the first image and/or the second image can be performed in order to digitally compensate for artefacts and distortions that can be introduced on account of optical components within the display apparatus.

In an example, whilst processing the input image to generate at least the first image and the second image, the image processing module may select the image rendering format of the first image and the second image. In one scenario, the selected image rendering format may be the set of two-dimensional bitmaps. In such a scenario, the bitmaps of the set may be arranged in a manner that the innermost bitmap has the highest resolution and the outermost bitmap has the lowest resolution among the bitmaps of the set, wherein resolution of a given bitmap varies inversely with distance of the given bitmap from a centre of the arrangement. In other words, the bitmaps of the set are arranged so as to emulate vision of the human visual system. Furthermore, there may exist at least one bitmap within the set. Optionally, the bitmaps of the set could also be cropped to reduce an amount of information pertaining to the first image and the second image. In another scenario, the selected image rendering format may be the single dynamic resolution texture. In one case, the texture may have a rectangular shape, wherein edges of the texture have lower resolution (and consequently, lower amount of visual detail) as compared to a central portion of the texture. In other words, pixels per unit area on the edges of the texture are lesser than pixels per unit area of the central portion. This allows for reducing the amount of information pertaining to the first image and the second image, whilst emulating vision of the human visual system. In another case, the texture may have a circular shape, wherein circular edges of the texture have lower resolution (and consequently, lower amount of visual detail) as compared to a central portion of the texture. Notably, such a texture includes a spherical two-dimensional arrangement of pixels, a spiral curve arrangement of pixels, or multiple spiral curve arrangement of pixels.

In another example, whilst processing the input image to generate at least the first image and the second image, the image processing module may select the rendering duration of both the first image and the second image to be equal to 0.25 seconds.

As mentioned previously, the display apparatus comprises at least one first image renderer and at least one second image renderer that, in operation, render the first image and the second image, respectively. Throughout the present disclosure, the term “first image renderer” relates to equipment configured to facilitate rendering of the first image. Similarly, the term “second image renderer” relates to equipment configured to facilitate rendering of the second image. The first image and the second image are transmitted from the image processing module to the at least one first image renderer and the at least one second image renderer, respectively, via a high-speed physical or wireless data communication channel.

Optionally, the at least one first image renderer and/or the at least one second image renderer is/are implemented by way of at least one projector and a projection screen associated therewith. Optionally, a single projection screen may be shared between separate projectors employed to implement the at least one first image renderer and the at least one second image renderer. Optionally, the at least one projector is selected from the group consisting of: a Liquid Crystal Display (LCD)-based projector, a Light Emitting Diode (LED)-based projector, an Organic LED (OLED)-based projector, a Liquid Crystal on Silicon (LCoS)-based projector, a Digital Light Processing (DLP)-based projector, and a laser projector.

As an example, when a given image renderer is implemented by way of a given projector and a given projection screen associated therewith, a beam of light that is projected from the given projector towards the given projection screen could have a variable size. Such a variable-sized beam allows for providing an image scaling effect whist rendering a given image. Notably, the image processing module could be configured to control the size of the beam.

Optionally, the at least one first image renderer and/or the at least one second image renderer is/are implemented by way of at least one display. Optionally, in this regard, the at least one first image renderer is implemented by way of at least one first display configured to emit the projection of the rendered first image therefrom, and the at least one second image renderer is implemented by way of at least one second display configured to emit the projection of the rendered second image therefrom. In such a case, the term “first display” used herein relates to a display (or screen) configured to display the first image thereon. Similarly, the term “second display” used herein relates to a display (or screen) configured to display the second image thereon. Optionally, the at least one first display and/or the at least one second display are selected from the group consisting of: a Liquid Crystal Display (LCD), a Light Emitting Diode (LED)-based display, an Organic LED (OLED)-based display, a micro OLED-based display, a Liquid Crystal on Silicon (LCoS)-based display, and a Cathode Ray Tube-based display.

As an example, when a given image renderer is implemented by way of a two-dimensional pixel array based display, the image processing module may transmit single or multiple colour values to various locations on the two-dimensional pixel array based display. Such single or multiple colour values can be used in scaled form on the two-dimensional pixel array based display, for rendering a given image.

Optionally, the at least one first image renderer comprises at least two first image renderers, at least one of the at least two first image renderers being arranged to be used for a left eye of the user, and at least one of the at least two first image renderers being arranged to be used for a right eye of the user. Similarly, optionally, the at least one second image renderer comprises at least two second image renderers, at least one of the at least two second image renderers being arranged to be used for the left eye of the user, and at least one of the at least two second image renderers being arranged to be used for the right eye of the user.

Optionally, the at least one first image renderer and/or the at least one second image renderer is/are used for both eyes of the user on a shared-basis.

Optionally, the image processing module is configured to generate the first image and the second image, based also upon an operational status of the at least one first image renderer and the at least one second image renderer. Optionally, in such a case, the at least one first image renderer and the at least one second image renderer communicate their corresponding operational statuses to the image processing module either continuously, periodically, or intermittently. Notably, the term “operational status” of a given image renderer indicates a current functional characteristic of the given image renderer. Examples of such functional characteristics include, but are not limited to, a brightness intensity of the given image renderer, display resolution of the given image renderer, and whether or not the given image renderer is in operation. It will be appreciated that knowledge of the aforesaid operational status allows for the image processing module to suitably generate the first image and the second image in a manner that they can be properly rendered at the at least one first image renderer and the at least one second image renderer without adversely impacting the user's viewing experience.

Optionally, whilst processing the input image to generate at least the first image and the second image, the image processing module is configured to perform at least one of:
adjustment of the rendering parameter of the first image and/or the second image;
addition or removal of image pre-processing, intermediate processing and post-processing phases for the first image and/or the second image, based upon the operational status of the at least one first image renderer and the at least one second image renderer.

In an example, operational statuses X1 and X2 of a first image renderer and a second image renderer may indicate brightness intensity INT1 of the first image renderer to be less than brightness intensity INT2 of the second image renderer. In such an example, the image processing module may add an image pre-processing phase for the first image wherein brightness of the first image is increased to compensate for its lower brightness intensity INT1. As a result, resultant intensities of the displayed first and second images are substantially similar, thereby, providing a substantially-uniformly bright visual scene to the user.

In another example, operational statuses Y1 and Y2 of the first image renderer and the second image renderer may indicate display resolution R1 of the first image renderer to be less than display resolution R2 of the second image renderer. In such an example, the image processing module may reduce image rendering resolution of the first image (for example, using pixel binning) in a manner that the first image can be properly displayed at the first image renderer. As a result, displayed and apparent resolution of the first image is substantially lesser than that of the second images, when the user views the visual scene.

As mentioned previously, the display apparatus comprises at least one optical combiner for optically combining the projection of the first image with the projection of the second image. Throughout the present disclosure, the term “optical combiner” used herein relates to equipment (for example, such as optical elements) for optically combining the projection of the first image and the projection of the second image to constitute the visual scene. Beneficially, the at least one optical combiner could be configured to simulate active foveation of a human visual system. In operation, the at least one optical combiner is controlled to optically combine the projection of the first image with the projection of the second image in a manner that within the visual scene, the predicted gaze location of the user is depicted by way of the second image that has a higher resolution as compared to the first image whereas other regions of the visual scene are depicted by way of the first image. It is to be understood that the predicted gaze location and the predicted gaze velocity and/or acceleration is transmitted in raw or processed from, from the gaze predictor module to the at least one optical combiner, via a high-speed physical or wireless data communication channel.

Optionally, the at least one optical combiner comprises at least one first optical element that is arranged for any of: allowing the projection of the first image to pass through substantially, whilst reflecting the projection of the second image substantially; or allowing the projection of the second image to pass through substantially, whilst reflecting the projection of the first image substantially. The at least one first optical element is arranged to combine optical paths of the projections of the first and second images. Beneficially, such an arrangement of the at least one first optical element facilitates projection of the second image on and around the fovea of the user's eyes, and facilitates projection of the first image on the retina of the user's eyes, of which the fovea is just a small part.

Optionally, the at least one first optical element is implemented by way of at least one of: a semi-transparent mirror, a semi-transparent film, a prism, a lens, a polarizer, a beam splitter, an optical waveguide.

Optionally, the image processing module is configured to determine a region of interest of the input image, based upon the predicted gaze location and the predicted gaze velocity and/or acceleration, wherein the first image and the second image are to be generated in a manner that the second image substantially corresponds to the region of interest of the input image, whilst the first image substantially corresponds to an entirety of the input image. In such a case, the region of interest would be represented within both the first image and the second image, albeit at different resolutions. Specifically, the second image represents the region of interest at a higher resolution as compared to the first image. The term “region of interest” relates to a region of the input image which substantially corresponds to the predicted gaze location of the user. Notably, the region of interest can be understood to be a fixation region within the input image, whereat the user's gaze is predicted to be focused when the user would view the input image. As a result, the region of interest is to be projected onto the fovea of the user's eyes, thereby, allowing for the region of interest to be resolved with maximum visual acuity of the user's eyes. The region of interest can also be referred to as a “region of visual accuracy” of the input image.

Optionally, a size of the first image is substantially larger than a size of the second image. This can be attributed to the fact that optionally, the second image substantially corresponds to the region of interest of the input image, whilst the first image substantially corresponds to an entirety of the input image.

Optionally, the first image is to be generated in a manner that a region of the first image that substantially corresponds to the region of interest of the input image is masked, wherein the projection of the second image is to substantially overlap with a projection of the masked region of the first image on the at least one optical combiner. Notably, since the region of interest of the input image is represented in different resolutions within both the first image and the second image, the overlap (or superimposition) of the projections of the first and second images can result in optical distortion of appearance of their common region (specifically, the region of interest). In order to overcome such a problem, the aforesaid masking operation allows for obscuring the region of interest depicted within the first image, so that the visual scene formed upon optical combination of the projections of the first and second images depicts the region of interest of the input image by utilizing the second image only, since the second resolution (of the second image) is higher than the first resolution (of the first image). As a result of the masking operation, in the visual scene, the region of interest is depicted by utilizing the high-resolution second image whereas the remaining region of the input image is depicted by utilizing the low-resolution first image. Therefore, when the user views the visual scene, the region of interest corresponding to the gaze location of the user appears to have more visual detail with respect to other regions of the visual scene, thereby, allowing for the display apparatus to emulate foveation characteristics of the human visual system.

It will be appreciated that the first image and second image are rendered substantially simultaneously in order to avoid time lag during optical combination of projections thereof. Optionally, the steps of rendering the first and second images and optically combining their projections occur substantially simultaneously, and are repeated for subsequent sets of first and second images corresponding to each image of the sequence of images corresponding to the visual scene.

As mentioned previously, the display apparatus further comprises the image steering unit that is configured to determine, based upon the predicted gaze location and the predicted gaze velocity and/or acceleration, the region of the at least one optical combiner onto which the projection of the second image is to be focused, and to make the adjustment to focus the projection of the second image on said region of the at least one optical combiner. Throughout the present disclosure, the term “image steering unit” used herein relates to equipment (for example, such as optical elements, electromechanical components, and so forth) for controlling a location of focusing the projection of the second image upon the at least one optical combiner. In other words, the image steering unit allows for controlling a manner in which the first image and the second image are optically combined at the at least one optical combiner, for adjusting apparent foveation characteristics of the visual scene according to the user's gaze. Specifically, by using the image steering unit in the aforesaid manner, the high-resolution second image can be optically aligned to correspond to the predicted gaze location of the user. As a result, when the user would gaze at the predicted gaze location whilst viewing the visual scene, he/she would view the region corresponding to the predicted gaze location at a higher resolution as compared to other regions of the visual scene.

It will be appreciated that the image steering unit would be adjusted according to the last predicted gaze location and the last predicted gaze velocity and/or acceleration of the user, at all times. This allows for the image steering unit to ensure that arrangement of components within the display apparatus is substantially-optimal prior to actual change in the user's gaze, and therefore, minimal time would be required for the components to adjust when the actual change in the user's gaze occurs.

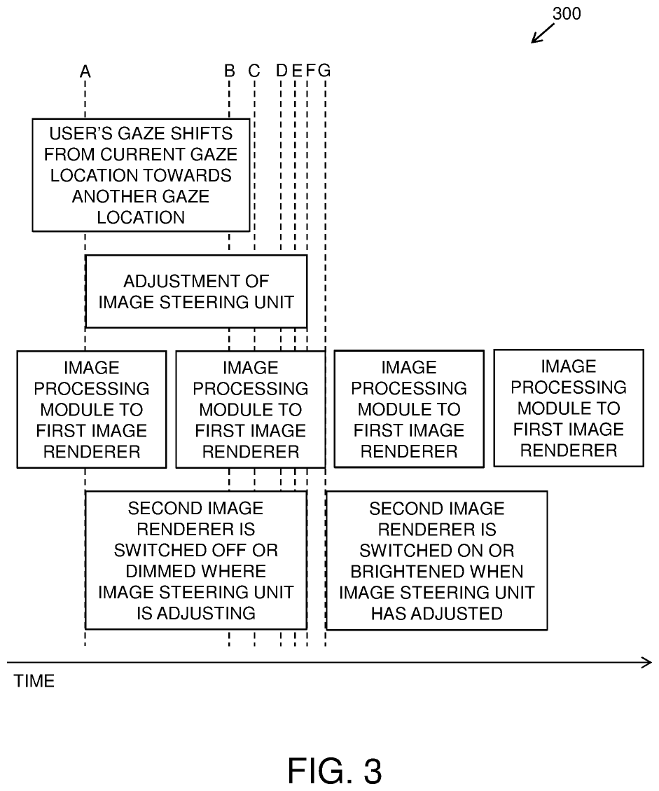

As mentioned previously, the at least one second image renderer is to be switched off or dimmed during an adjusting phase of the image steering unit when the image steering unit is making the adjustment. Notably, the “adjusting phase” of the image steering unit relates to a time duration in which an arrangement of the image steering unit is adjusted (for example, by movement of its constituent components) in accordance with the predicted gaze location and the predicted gaze velocity and/or acceleration of the user. Furthermore, such an “adjusting phase” occurs after the user's gaze starts to shift from the current gaze location of the user within the visual scene. Upon such a shift in the user's gaze, the gaze predictor module predicts the gaze location and the gaze velocity and/or acceleration of the user. Furthermore, the gaze predictor module communicates such predictions to the image steering unit, thereby, initiating the adjustment phase of the image steering unit. The beginning of such an adjusting phase of the image steering unit is illustrated as time A in FIG. 3.

It will be appreciated that movement of the user's gaze could be by way of saccadic movements of the user's eyes, pursuit movements of the user's eyes, and the like. The “saccadic movements” relate to movement of the user's eyes from one region of interest to another whereas the “pursuit movements” relate to smooth eye-movements that occur when the user's eyes follow a moving object from one location within the visual scene to another location.

During the adjusting phase, since the user's gaze is continuously changing, the at least one second image renderer is to be switched off or dimmed in order to avoid presenting an optically distorted visual scene to the user. Notably, during the adjusting phase, even though the first and second image are properly generated, their optical combination is likely to be suboptimal. This may be attributed to the fact that since the image steering unit undergoes adjustment (for example, by way of movement of its components) during the adjusting phase, it is not arranged in an optimal manner for proper optical combination. As a result, during the adjusting phase, the image steering unit would incorrectly focus the projection of the second image onto unsuitable (namely, erroneous) regions of the at least one optical combiner. Therefore, during the adjusting phase, the at least one second image renderer is to be switched off or dimmed whilst the first image is continued to be shown to the user of the display apparatus. Furthermore, the at least one second image renderer is to be switched off or dimmed during the adjusting phase of the image steering unit for saving power (that would be required to render the second image).

Optionally, the image steering unit comprises at least one actuator for moving at least one of:
the at least one second image renderer with respect to the at least one optical combiner,
the at least one optical combiner,
at least one optical element positioned on an optical path between the at least one second image renderer and the at least one optical combiner. Notably, the image steering unit implements the aforesaid movement operation when the user's gaze is predicted to shift from the current gaze location to the predicted gaze location, so as to allow the projection of the second image to be focused upon the at least one optical combiner at a desired region, upon completion of such a shift in the user's gaze direction. The movement of at least one of the aforesaid components may, for example, allow for adjusting an optical path of the projection of the second image, thereby, focusing the projection of the second image at the desired region of the at least one optical combiner. More optionally, the movement implemented by way of the at least one actuator includes at least one of: displacement (horizontally and/or vertically), rotation and/or tilting of at least one of: the at least one second image renderer, the at least one optical combiner, the at least one optical element. In operation, the at least one actuator employs an actuation signal (for example, such as an electric current, hydraulic pressure, and so forth).

Optionally, the image steering unit comprises the at least one optical element positioned on the optical path between the at least one second image renderer and the at least one optical combiner. Therefore, the projection of the second image emanating from the at least one second image renderer is directed towards the at least one optical element, wherefrom the projection of the second image is directed towards the at least one optical combiner. In such a case, the at least one optical element allows for adjusting the optical path of the projection of the second image, thereby, facilitating the image steering unit to control the location of focusing the projection of the second image upon the at least one optical combiner. Optionally, the at least one optical element is implemented by way of at least one of: a lens, a prism, a mirror, a beam splitter, an optical waveguide.

Optionally, the gaze predictor module is configured to process sensor data collected by the configuration of gaze sensors to determine when the user's gaze stops shifting. As an example, the sensor data may include multiple images of the user's eyes, wherein a position of glints (reflections of light emitted by illuminators onto the user's eyes) within the multiple images is substantially-constant. Therefore, the gaze predictor module may process such sensor data to determine the current gaze velocity of the user to be equal or nearly equal to zero. As a result, the user's gaze is determined to have stopped shifting. An event when the user's gaze stops shifting, is illustrated as time B in FIG. 3. Optionally, when the user's gaze is determined to stop shifting, the image processing module is to be operated to process the input image.

Furthermore, optionally, the gaze predictor module is configured to predict a full focus time duration for the user's eyes, based upon the current gaze velocity and/or acceleration of the user. Such a prediction may be made whilst the gaze predictor module determines the user's gaze to stop moving. The term “full focus time duration” relates to a time duration within which the eyes of the user are able to fully focus on a given region of the visual scene. Optionally, the image processing module is configured to process the input image during the full focus time duration for the user's eyes.

Moreover, optionally, the gaze predictor module is configured to process sensor data collected by the configuration of gaze sensors to detect when the user's eyes are fully focused. An event when the user's eyes are detected to be fully focused, is illustrated as time C in FIG. 3.

Optionally, the image steering unit and/or the gaze predictor module is/are configured to estimate a time duration of the adjusting phase of the image steering unit, and to communicate the estimated time duration to other components of the display apparatus. An event when such an estimated time duration of the adjusting phase is communicated, is illustrated as time D in FIG. 3. It will be appreciated that an accuracy of a given prediction by the gaze predictor module can depend inversely upon time taken by the gaze predictor module to make the given prediction.

Optionally, the image processing module is configured to communicate an estimated time for generation of at least the first image and the second image to other components of the display apparatus. In such a case, upon receiving such a communication, the at least one first image renderer and the at least one second image renderer can obtain the first image and the second image, respectively, from the image processing module as soon as the first image and the second image are generated. Alternatively, upon receiving such a communication, the at least one first image renderer and the at least one second image renderer can communicate with the image processing module for obtaining the first image and the second image, respectively, from the image processing module only when the adjustment of the image steering unit has been made. Optionally, if the estimated time duration of the adjusting phase of the image steering unit is lesser than the estimated time for generation of at least the first image and the second image, the image processing module is configured to receive a communication for speeding up its image processing operations from at least one of the other components of the display apparatus. An event when the estimated time for generation of at least the first image and the second image is communicated, is illustrated as time E in FIG. 3.

Optionally, the at least one second image renderer is to be switched on or brightened during a focus phase of the image steering unit when the adjustment has been made. Notably, the “focus phase” of the image steering unit relates to a period in which the image steering unit is arranged in an optimal manner for focusing the projection of the second image onto the at least one optical combiner, according to the predicted gaze location. During the focus phase, fixational movements (for example, such as micro-saccadic movements) of the user's eyes allow for the user to focus upon the predicted gaze location of the user. Therefore, optionally, the focus phase of the image steering unit substantially corresponds to a fixation phase of the user's eyes. Furthermore, the focus phase follows the adjusting phase of the image steering unit. Once the adjustment of the image steering unit is complete, the image steering unit is arranged in a manner that allows for focusing the projection of the second image onto a correct region of the at least one optical combiner. Therefore, since arrangement of the image steering unit, the at least one second image renderer and the at least one optical combiner is appropriate, the at least one second image renderer can be switched on or brightened to display the second image to the user. The beginning of such a focus phase of the image steering unit is illustrated as time F in FIG. 3 and an event of switching on or brightening the at least one second image renderer is illustrated as time G in the FIG. 3.

Optionally, the image processing module is configured to process a subsequent input image to generate only a single image, when the predicted gaze velocity and/or acceleration is indicative of a saccadic movement of the user's eyes, and wherein the at least one first image renderer, in operation, renders the single image, further wherein the at least one second image renderer is to be switched off or dimmed during the saccadic movement of the user's eyes. Optionally, in this regard, the single image substantially corresponds to an entirety of the subsequent input image. Notably, during the aforesaid saccadic movement of the user's eyes, the user's gaze changes (namely, shifts) from one gaze location to another. Since such saccadic movements typically last for about 5 to 80 milliseconds and occur about 3-4 times per second, there exists a reasonable time duration of the adjustment phase of the image steering unit whist the user uses the display apparatus. In order to ensure that the user continues to enjoy an uninterrupted viewing experience even during such adjustment phases of the image steering unit, the generated single image is rendered continuously by way of the at least one first image renderer. In such a case, when the generated single image substantially corresponds to an entirety of the subsequent input image, the user is continuously shown a complete view (from among various views of the visual scene) represented by the subsequent input image at a substantially-uniform resolution. In other words, by operating the display apparatus in the aforesaid manner, the user is shown the visual scene in uniform resolution during saccadic movement of the user's eyes (namely, during the adjusting phase of the image steering unit) and the user is shown the visual scene emulating foveation properties of the human visual system during the fixational movements of the user's eyes (namely, during the focus phase of the image steering unit).

It will be appreciated that generally, the saccadic movements of the user's eyes and the fixational movements of the user's eyes occur alternatively. In other words, every saccadic movement of the user's eyes is succeeded by a corresponding fixational movement of the user's eyes. The fixational movement of the user's eyes can again be succeeded by another saccadic movement of the user's eyes. Specifically, the fixational movements of the user's eyes occur during the fixation phase of the user's eyes. During such a fixation phase, the visual system of the user receives visual information from its foveal and peripheral vision, processes such visual information, and calculates a time of occurrence of the next saccadic movement. Generally, a time duration of a given fixation phase is about 250 milliseconds.

The present disclosure also relates to the method as described above. Various embodiments and variants disclosed above apply mutatis mutandis to the method.

Optionally, the method further comprises switching on or brightening the at least one second image renderer during the focus phase of the image steering unit when the adjustment has been made.

Optionally, the method further comprises:
processing the subsequent input image to generate only the single image, when the predicted gaze velocity and/or acceleration is indicative of the saccadic movement of the user's eyes;
rendering the single image via the at least one first image renderer; and
switching off or dimming the at least one second image renderer during the saccadic movement of the user's eyes.

Optionally, in the method, the step of predicting the gaze location and the gaze velocity and/or acceleration of the user is performed based also upon information pertaining to the visual scene being presented to the user.

Optionally, in the method, the information pertaining to the visual scene comprises information indicative of the location of the object present in the visual scene that has at least one of: the audio feature of interest, the visual feature of interest, the physical interaction with another object present in the visual scene.

Optionally, the method further comprises determining the region of interest of the input image, based upon the predicted gaze location and the predicted gaze velocity and/or acceleration, wherein the first image and the second image are generated in a manner that the second image substantially corresponds to the region of interest of the input image, whilst the first image substantially corresponds to an entirety of the input image.

Optionally, in the method, the first image is generated in a manner that the region of the first image that substantially corresponds to the region of interest of the input image is masked, wherein the projection of the second image substantially overlaps with the projection of the masked region of the first image on the at least one optical combiner.

Optionally, in the method, the step of generating the first image and the second image is performed based also upon the operational status of the at least one first image renderer and the at least one second image renderer.

Optionally, the method further comprises employing the at least one actuator of the image steering unit to move at least one of:
the at least one second image renderer with respect to the at least one optical combiner,
the at least one optical combiner,
the at least one optical element positioned on an optical path between the at least one second image renderer and the at least one optical combiner.

### DETAILED DESCRIPTION OF THE DRAWINGS

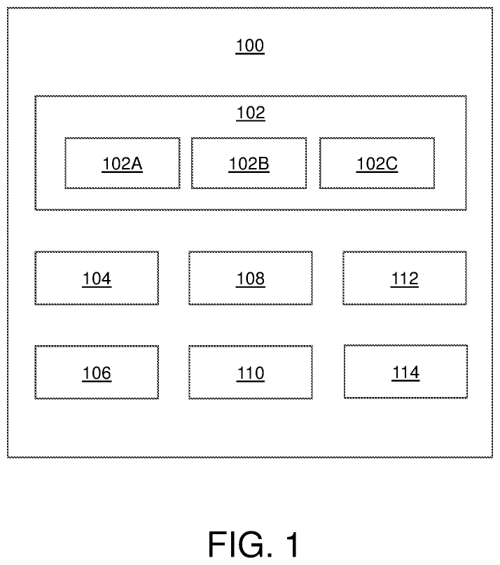

Referring to FIG. 1, illustrated is a block diagram of architecture of a display apparatus 100, in accordance with an embodiment of the present disclosure. The display apparatus 100 comprises a configuration of gaze sensors 102; a gaze predictor module 104; an image processing module 106; at least one first image renderer, depicted as a first image renderer 108; at least one second image renderer, depicted as a second image renderer 110; at least one optical combiner, depicted as an optical combiner 112; and an image steering unit 114. As shown, the configuration of gaze sensors 102 comprises gaze sensors for detecting a gaze direction of a user, depicted, for example, as a set 102A of an illuminator and an image sensor, and gaze sensors for tracking a head orientation of the user, depicted, for example, as a gyroscope 102B and an accelerometer 102C.

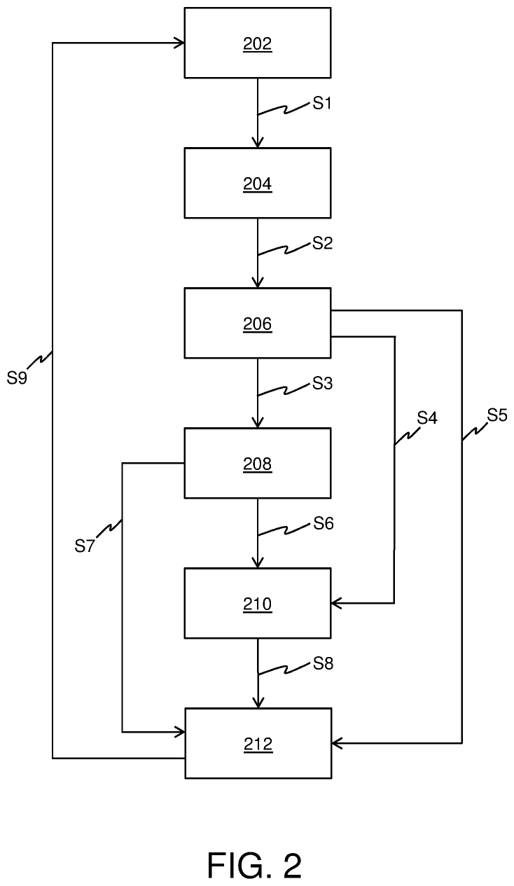

Referring to FIG. 2, illustrated is an exemplary information flow when a user uses a display apparatus, in accordance with an embodiment of the present disclosure. The display apparatus comprises a configuration of gaze sensors 204; a gaze predictor module 206; an image processing module 208; at least one first image renderer and at least one second image renderer, collectively depicted as image renderers 210; at least one optical combiner and an image steering unit, collectively depicted as optics 212. At step S1, sensor data related to gaze of a user's eye 202 is collected by the configuration of gaze sensors 204. At step S2, the sensor data collected by the configuration of gaze sensors 204 is obtained by the gaze predictor module 206. The gaze predictor module 206 processes the sensor data to determine a current gaze location and a current gaze velocity and/or acceleration of the user's eye 202, and predicts a gaze location and a gaze velocity and/or acceleration of the user's eye 202, based at least partially upon the current gaze location and the current gaze velocity and/or acceleration. At step S3, the predicted gaze location and the gaze velocity and/or acceleration of the user's eye 202 are transmitted by the gaze predictor module 206 to the image processing module 208. The image processing module 208 processes an input image, based upon the predicted gaze location and the predicted gaze velocity and/or acceleration of the user's eye 202, to generate at least a first image and a second image, wherein the first image has a first resolution, while the second image has a second resolution, the second resolution being higher than the first resolution. At step S4, the predicted gaze location and the gaze velocity and/or acceleration of the user's eye 202 are transmitted by the gaze predictor module 206 to the image renderers 210. At step S5, the predicted gaze location and the gaze velocity and/or acceleration of the user's eye 202 are transmitted by the gaze predictor module 206 to the optics 212. The steps S3, S4 and S5 can occur substantially simultaneously. At step S6, the first image and the second image are transmitted by the image processing module 208 to the image renderers 210. The at least one first image renderer and the at least one second image renderer, in operation, render the first image and the second image, respectively. At step S7, an estimated time for generation of at least the first image and the second image is communicated from the image processing module 208 to the optics 212. At step S8, a projection of the first image and a projection of the second image are directed from the image renderers 210 towards the optics 212. Notably, the at least one optical combiner optically combines the projection of the first image with the projection of the second image. Furthermore, the image steering unit determines, based upon the predicted gaze location and the predicted gaze velocity and/or acceleration, a region of the at least one optical combiner onto which the projection of the second image is to be focused, and makes an adjustment to focus the projection of the second image on said region of the optical combiner. Moreover, the at least one second image renderer is switched off or dimmed during an adjusting phase of the image steering unit when the image steering unit is making the adjustment. At step S9, a combined projection including optically combined projections of the first image and the second image, is directed towards the user's eye 202.

Referring to FIG. 3, illustrated is an exemplary timeline 300 of exemplary operational steps of a display apparatus, in accordance with an embodiment of the present disclosure. It is to be understood that a projection of a first image is to be continuously rendered upon a first image renderer and a projection of a second image is to be rendered upon a second image renderer based upon events corresponding to the exemplary operational steps presented in the timeline 300. Notably, the projection of the first image and the projection of the second image collectively constitute an input image pertaining to a visual scene that is to be presented to a user, via the display apparatus. The display apparatus comprises a configuration of gaze sensors; a gaze predictor module; an image processing module; at least one first image renderer; at least one second image renderer; at least one optical combiner and an image steering unit. At time A, an adjusting phase of the image steering unit begins. Notably, the user's gaze starts to shift from a current gaze location of the user within the visual scene, prior to the time A. Upon such a shift in the user's gaze, the gaze predictor module predicts the gaze location and the gaze velocity and/or acceleration of the user. Furthermore, the gaze predictor module communicates such predictions to the image steering unit, thereby, initiating the adjustment phase of the image steering unit. Furthermore, at time A the second image renderer is switched off or dimmed during such an adjusting phase of the image steering unit. At time B, the user's gaze stops shifting and the gaze predictor module predicts a full focus time duration for the user's eyes, based upon a current gaze velocity and/or acceleration of the user. At time C, the user's eyes are detected to be fully focused. Notably, the gaze predictor module processes sensor data collected by the configuration of gaze sensors to detect when the user's eyes are fully focused. At time D, an estimated time duration of the adjusting phase is communicated to other components of the display apparatus. Notably, the image steering unit and/or the gaze predictor module estimates the time duration of the adjusting phase of the image steering unit and communicates the estimated time duration to other components of the display apparatus. At time E, an estimated time for generation of the second image is communicated to other components of the display apparatus. Notably, the image processing module communicates the estimated time for generation of the second image to other components of the display apparatus. At time F, a focus phase of the image steering unit begins. Notably, by time F, the image steering unit is arranged in an optimal manner for focusing the projection of the second image onto the optical combiner, according to a predicted gaze location. At time G, the second image renderer is switched on or brightened. Notably, since the adjustment of the image steering unit is complete, during the focus phase, the image steering unit is arranged in a manner that allows for focusing the projection of the second image onto a correct region of the optical combiner. As a result, the second image renderer can be switched on or brightened to display the second image to the user, in addition to the first image that is already being displayed to the user throughout the timeline 300.

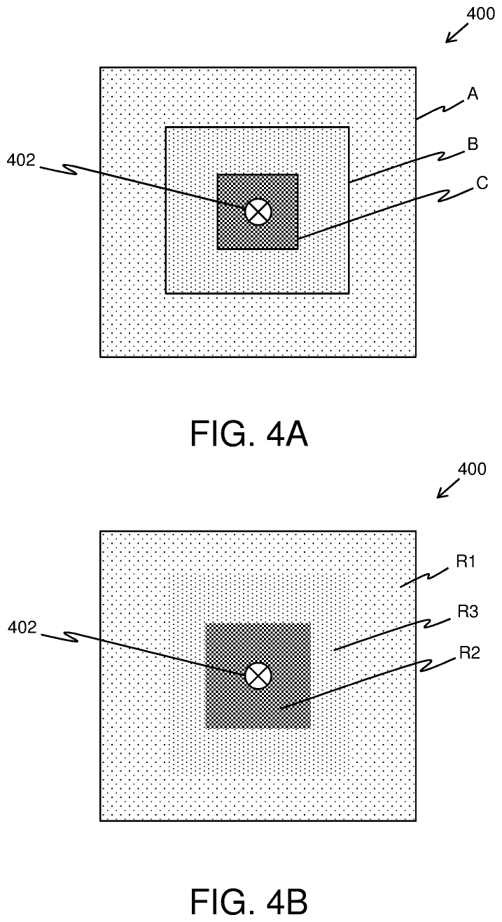

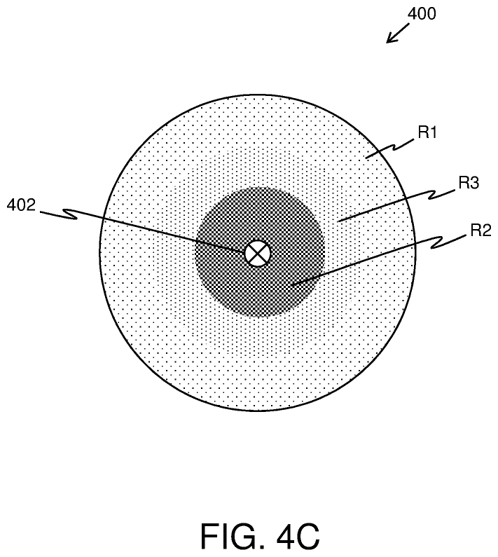

Referring to FIGS. 4A, 4B and 4C, illustrated are exemplary illustrations of image rendering formats of a given image 400, that act as input to a given image renderer, in accordance with various embodiments of the present disclosure. It may be understood by a person skilled in the art that the FIGS. 4A, 4B and 4C include simplified exemplary illustrations of image rendering formats of the given image 400 for sake of clarity, which should not unduly limit the scope of the claims herein. The person skilled in the art will recognize many variations, alternatives, and modifications of embodiments of the present disclosure.

Notably, in FIGS. 4A, 4B and 4C, a gaze location of a user's eye is depicted by way of an encircled cross 402.

In FIG. 4A, the image rendering format of the given image 400 is a set of two-dimensional bitmaps (depicted by way of different types of dotted hatching). The bitmaps of the set are arranged in a manner that an innermost bitmap (depicted as a region enclosed by boundary C) has a highest resolution and an outermost bitmap (depicted as region between boundaries A and B) has the lowest resolution among the bitmaps of the set. An intermediate bitmap (depicted as a region between boundaries B and C) between the innermost bitmap and the outermost bitmap, has an intermediate resolution that is greater than the resolution of the outermost bitmap but is lesser than the resolution of the innermost bitmap.

In FIGS. 4B and 4C, the image rendering format of the given image 400 has a single dynamic resolution texture. In FIG. 4B, the single dynamic resolution texture has a rectangular shape whereas in FIG. 4C, the single dynamic resolution texture has a circular shape. In the single dynamic resolution texture of FIGS. 4B and 4C, edges (depicted as a region R1) of the texture have lower resolution (and consequently, lower amount of visual detail) as compared to a central portion (depicted as a region R2) of the texture. Notably, pixels per unit area on the edges R1 of the texture are lesser than pixels per unit area of the central portion R2 of the texture. Furthermore, pixels per unit area on an intermediate region (depicted as a region R3) of the texture are higher than the pixels per unit area on the edges R1 of the texture, but lesser than the pixels per unit area of the central portion R2 of the texture.

As shown in FIG. 4C, the single dynamic resolution texture can include a spherical two-dimensional arrangement of pixels, a spiral curve arrangement of pixels, or multiple spiral curve arrangement of pixels.

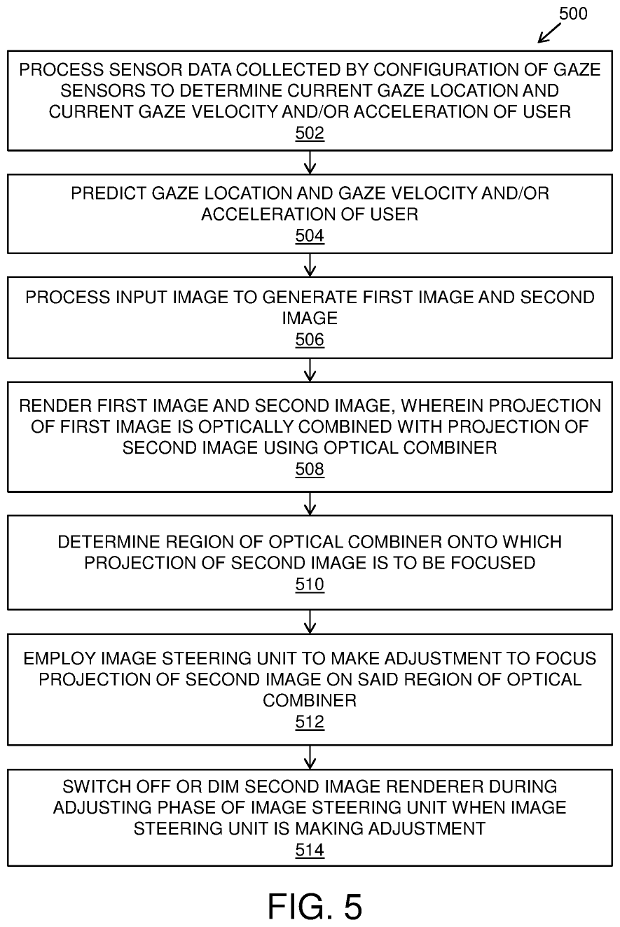

Referring to FIG. 5, illustrated are steps of a method 500 of displaying, via a display apparatus, in accordance with an embodiment of the present disclosure. At step 502, sensor data collected by a configuration of gaze sensors of the display apparatus is processed to determine a current gaze location and a current gaze velocity and/or acceleration of a user. At step 504, a gaze location and a gaze velocity and/or acceleration of the user is predicted, based at least partially upon the current gaze location and the current gaze velocity and/or acceleration. At step 506, an input image is processed, based upon the predicted gaze location and the predicted gaze velocity and/or acceleration, to generate at least a first image and a second image. The first image has a first resolution, while the second image has a second resolution, the second resolution being higher than the first resolution. At step 508, the first image and the second image are rendered via at least one first image renderer and at least one second image renderer of the display apparatus, respectively, wherein a projection of the first image is optically combined with a projection of the second image using at least one optical combiner of the display apparatus. At step 510, a region of the at least one optical combiner onto which the projection of the second image is to be focused is determined, based upon the predicted gaze location and the predicted gaze velocity and/or acceleration. At step 512, an image steering unit of the display apparatus is employed to make an adjustment to focus the projection of the second image on said region of the at least one optical combiners. At step 514, the at least one second image renderer is switched off or dimmed during an adjusting phase of the image steering unit when the image steering unit is making the adjustment.

The steps 502 to 514 are only illustrative and other alternatives can also be provided where one or more steps are added, one or more steps are removed, or one or more steps are provided in a different sequence without departing from the scope of the claims herein.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A display apparatus comprising:
a configuration of gaze sensors;
a gaze predictor module configured to process sensor data collected by the configuration of gaze sensors to determine a current gaze location and a current gaze velocity and/or acceleration of a user, and to predict a gaze location and a gaze velocity and/or acceleration of the user, based at least partially upon the current gaze location and the current gaze velocity and/or acceleration;
an image processing module configured to process an input image, based upon the predicted gaze location and the predicted gaze velocity and/or acceleration, to generate at least a first image and a second image, wherein the first image has a first resolution, while the second image has a second resolution, the second resolution being higher than the first resolution;
at least one first image renderer and at least one second image renderer that, in operation, render the first image and the second image, respectively;
at least one optical combiner for optically combining a projection of the first image with a projection of the second image; and
an image steering unit configured to determine, based upon the predicted gaze location and the predicted gaze velocity and/or acceleration, a region of the at least one optical combiner onto which the projection of the second image is to be focused, and to make an adjustment to focus the projection of the second image on said region of the at least one optical combiner;
wherein the at least one second image renderer is to be switched off or dimmed during an adjusting phase of the image steering unit when the image steering unit is making the adjustment.

2. The display apparatus of claim 1, wherein the at least one second image renderer is to be switched on or brightened during a focus phase of the image steering unit when the adjustment has been made.

3. The display apparatus of claim 1, wherein the image processing module is configured to process a subsequent input image to generate only a single image, when the predicted gaze velocity and/or acceleration is indicative of a saccadic movement of the user's eyes, and wherein the at least one first image renderer, in operation, renders the single image, further wherein the at least one second image renderer is to be switched off or dimmed during the saccadic movement of the user's eyes.

4. The display apparatus of claim 1, wherein the gaze predictor module is configured to predict the gaze location and the gaze velocity and/or acceleration of the user, based also upon information pertaining to a visual scene being presented to the user.

5. The display apparatus of claim 4, wherein the information pertaining to the visual scene comprises information indicative of a location of an object present in the visual scene that has at least one of: an audio feature of interest, a visual feature of interest, a physical interaction with another object present in the visual scene.

6. The display apparatus of claim 1, wherein the image processing module is configured to determine a region of interest of the input image, based upon the predicted gaze location and the predicted gaze velocity and/or acceleration, wherein the first image and the second image are to be generated in a manner that the second image substantially corresponds to the region of interest of the input image, whilst the first image substantially corresponds to an entirety of the input image.

7. The display apparatus of claim 6, wherein the first image is to be generated in a manner that a region of the first image that substantially corresponds to the region of interest of the input image is masked, wherein the projection of the second image is to substantially overlap with a projection of the masked region of the first image on the at least one optical combiner.

8. The display apparatus of claim 1, wherein the image processing module is configured to generate the first image and the second image, based also upon an operational status of the at least one first image renderer and the at least one second image renderer.

9. The display apparatus of claim 1, wherein the image steering unit comprises at least one actuator for moving at least one of:
the at least one second image renderer with respect to the at least one optical combiner,
the at least one optical combiner,
at least one optical element positioned on an optical path between the at least one second image renderer and the at least one optical combiner.

10. A method of displaying, via a display apparatus, the method comprising:
processing sensor data collected by a configuration of gaze sensors of the display apparatus to determine a current gaze location and a current gaze velocity and/or acceleration of a user;
predicting a gaze location and a gaze velocity and/or acceleration of the user, based at least partially upon the current gaze location and the current gaze velocity and/or acceleration;
processing an input image, based upon the predicted gaze location and the predicted gaze velocity and/or acceleration, to generate at least a first image and a second image, wherein the first image has a first resolution, while the second image has a second resolution, the second resolution being higher than the first resolution;
rendering, via at least one first image renderer and at least one second image renderer of the display apparatus, the first image and the second image, respectively, wherein a projection of the first image is optically combined with a projection of the second image using at least one optical combiner of the display apparatus;
determining, based upon the predicted gaze location and the predicted gaze velocity and/or acceleration, a region of the at least one optical combiner onto which the projection of the second image is to be focused;
employing an image steering unit of the display apparatus to make an adjustment to focus the projection of the second image on said region of the at least one optical combiner; and
switching off or dimming the at least one second image renderer during an adjusting phase of the image steering unit when the image steering unit is making the adjustment.

11. The method of claim 10, further comprising switching on or brightening the at least one second image renderer during a focus phase of the image steering unit when the adjustment has been made.

12. The method of claim 10, further comprising:
processing a subsequent input image to generate only a single image, when the predicted gaze velocity and/or acceleration is indicative of a saccadic movement of the user's eyes;
rendering the single image via the at least one first image renderer; and
switching off or dimming the at least one second image renderer during the saccadic movement of the user's eyes.

13. The method of claim 10, wherein the step of predicting the gaze location and the gaze velocity and/or acceleration of the user is performed based also upon information pertaining to a visual scene being presented to the user.

14. The method of claim 13, wherein the information pertaining to the visual scene comprises information indicative of a location of an object present in the visual scene that has at least one of: an audio feature of interest, a visual feature of interest, a physical interaction with another object present in the visual scene.

15. The method of claim 10, further comprising determining a region of interest of the input image, based upon the predicted gaze location and the predicted gaze velocity and/or acceleration, wherein the first image and the second image are generated in a manner that the second image substantially corresponds to the region of interest of the input image, whilst the first image substantially corresponds to an entirety of the input image.

16. The method of claim 15, wherein the first image is generated in a manner that a region of the first image that substantially corresponds to the region of interest of the input image is masked, wherein the projection of the second image substantially overlaps with a projection of the masked region of the first image on the at least one optical combiner.

17. The method of claim 10, wherein the step of generating the first image and the second image is performed based also upon an operational status of the at least one first image renderer and the at least one second image renderer.

18. The method of claim 10, further comprising employing at least one actuator of the image steering unit to move at least one of:
the at least one second image renderer with respect to the at least one optical combiner,
the at least one optical combiner,
at least one optical element positioned on an optical path between the at least one second image renderer and the at least one optical combiner.
